(19) United States
(12) Patent Application Publication
(10) Pub. No.: US 2015/0016511 A1
(43) Pub. Date: Jan. 15, 2015

(54) IMAGE COMPRESSION APPARATUS AND METHOD

(71) Applicant: Fujitsu Limited, Kawasaki-shi (JP)

(72) Inventors: Zheng WANG, Beijing (CN); Jianqing ZHU, Beijing (CN); Yan ZHENG, Beijing (CN); Jiangli YE, Beijing (CN); Kimihiko KAZUI, Kawasaki (JP)

(73) Assignee: Fujitsu Limited, Kawasaki-shi (JP)

(21) Appl. No.: 14/330,394

(22) Filed: Jul. 14, 2014

(30) Foreign Application Priority Data
Jul. 12, 2013 (CN) 201310294334.X

(51) Int. Cl. H04N 19/105; H04N 19/167; H04N 19/51; H04N 19/182

(52) U.S. Cl. CPC H04N 19/00024; H04N 19/00303; H04N 19/00248; H04N 19/00696
USPC 375/240.03; 375/240.16

(57) ABSTRACT

An image compression apparatus including an image segmenting unit to segment an image into a plurality of image blocks; a prediction unit to take an adjacent pixel to which each pixel points in the same angle as a reference pixel, and take a pixel value or a reconstruction value of the reference pixel as a prediction value; an encoding unit to encode a residual obtained by subtracting the prediction value from the pixel value, or a quantization coefficient obtained through a transformation and a quantization of the residual; and a reconstruction unit to add the prediction value with corresponding residual or a residual obtained through an inverse transformation and an inverse quantization of the quantization coefficient to obtain a reconstruction value of each pixel.

### CROSS REFERENCE TO RELATED APPLICATIONS

This application claims the benefit of Chinese Application No. 201310294334.X, filed Jul. 12, 2013, the disclosure of which is incorporated herein by reference.

### TECHNICAL FIELD

The present invention relates to the field of image processing, and particularly, to an image compression apparatus and a method for the same.

### BACKGROUND

With the continuous development of the computer technology, many artificial visual contents generated by the computer occur in addition to natural images. The natural images and the artificial visual contents together form composite images which have characteristics different from those of the natural images. Currently, the composite images are more and more popular, and they often need to be displayed at a remote client-side. Nowadays, the resolutions of videos and images are increasingly high, the frame rates are also continuously improved, and the data processing load in a composite image system is continuously growing. Thus, how to compress and transmit a composite image becomes a problem to be solved.

To be noted, the above introduction of the technical background is just made for the convenience of clearly and completely describing the technical solutions of the present invention, and to facilitate the understanding of a person skilled in the art. It shall not be deemed that the above technical solutions are known to a person skilled in the art just because they have been illustrated in the Background section of the present invention.

### SUMMARY

The embodiments of the present invention provide an image compression apparatus and a method for the same. An accurate prediction can be realized by taking an adjacent pixel as a reference pixel, thereby improving the quality of a compressed image. In addition, it only requires taking a pixel value or a reconstruction value of the reference pixel as a prediction value of the pixel, thereby reducing the calculation complexity.

According to an aspect of the embodiments of the present invention, an image compression apparatus is provided, including: an image segmenting unit configured to segment an original image into a plurality of image blocks according to a predetermined size combination; a prediction unit configured to take an adjacent pixel, to which each pixel in each image block points in the same predetermined angle, as a reference pixel of the pixel, and take a pixel value or a reconstruction value of the reference pixel as a prediction value of the pixel; an encoding unit configured to encode a residual obtained by subtracting the prediction value from the pixel value of each pixel in each image block, or a quantization coefficient obtained through a transformation and a quantization of the residual; and a reconstruction unit configured to add the prediction value of each pixel in each image block with corresponding residual or a residual obtained through an inverse transformation and an inverse quantization of the quantization coefficient, so as to obtain a reconstruction value of each pixel in each image block.

According to another aspect of the embodiments of the present invention, an image compression method is provided, including: segmenting an original image into a plurality of image blocks according to a predetermined size combination; taking an adjacent pixel, to which each pixel in each image block points in the same predetermined angle, as a reference pixel of the pixel, and taking a pixel value or a reconstruction value of the reference pixel as a prediction value of the pixel; adding the prediction value of each pixel in each image block with corresponding residual or a residual obtained through an inverse transformation and an inverse quantization of the quantization coefficient to obtain a reconstruction value of each pixel in each image block; and encoding a residual obtained by subtracting the prediction value from the pixel value of each pixel in each image block, or a quantization coefficient obtained through a transformation and a quantization of the residual.

The embodiments of the present invention have the beneficial effect of realizing an accurate prediction in the compression of a composite image, thereby improving the quality of the compressed image and reducing the calculation complexity.

With reference to the following descriptions and drawings, the specific embodiments of the present invention will be disclosed, and the manners of adopting the principle of the present invention will be pointed out. It shall be appreciated that the scope of the embodiments of the present invention are not limited thereto. Within the scope of the spirit and provisions of the accompanied claims, the embodiments of the present invention include many changes, modifications and equivalents.

Features described and/or illustrated with respect to one embodiment can be used in one or more other embodiments in a same or similar way, and/or combine with or replace features in other embodiments.

To be noted, the term “comprise/include” used herein specifies the presence of feature, integer, step or component, not excluding the presence or addition of one or more other features, integers, steps or components.

According to an aspect of the embodiments a method is provided including designating a first pixel adjacent to a second pixel as a reference pixel and designating the reference pixel as a prediction value and adding the prediction value to a corresponding pixel residual to produce a reconstruction value of the second pixel, where the designating is limited to pixels within a prediction area.

### BRIEF DESCRIPTION OF THE DRAWINGS

Many aspects of the present invention can be understood better with reference to the following drawings. The parts in the drawings are not drafted in proportion, but just for illustrating the principle of the present invention. For the convenience of illustrating and describing some portions of the present invention, corresponding portions in the drawings may be zoomed in or out. Elements and features described in a drawing or an embodiment of the present invention may be combined with elements and features illustrated in one or more other drawings or embodiments. In addition, the similar reference signs represent corresponding parts in several drawings, and also indicate corresponding parts used in more than one embodiment.

In the drawings:

FIG. 1 is a structure diagram of an image compression apparatus according to Embodiment 1 of the present invention;

FIG. 2 is a structure diagram of an image block to be processed and a reference image block according to Embodiment 1 of the present invention;

FIG. 3 is a schematic diagram of prediction modes according to Embodiment 1 of the present invention;

FIG. 4 is a structure diagram of an image compression apparatus according to Embodiment 2 of the present invention;

FIG. 5 is a structure diagram of an image compression apparatus according to Embodiment 3 of the present invention;

FIG. 6 is a flowchart of an image compression method according to Embodiment 4 of the present invention;

FIG. 7 is a flowchart of an image compression method according to Embodiment 5 of the present invention;

FIG. 8 is a flowchart of a method for determining a predetermined angle according to Embodiment 5 of the present invention;

FIG. 9 is a flowchart of a method for determining a predetermined size combination according to Embodiment 5 of the present invention; and

FIG. 10 is a flowchart of an image compression method according to Embodiment 6 of the present invention.

### DESCRIPTION OF THE EMBODIMENTS

The aforementioned and other features of the present invention will be more obvious through the following descriptions with reference to the drawings. The descriptions and the drawings specifically disclose the specific embodiments of the present invention, which are some of the embodiments capable of adopting the principle of the present invention. To be noted, the present invention is not limited to the described embodiments. On the contrary, the present invention includes any amendment, modification and their equivalents falling in the scope of the accompanied claims.

Currently, the existing image compression standards, such as JPEG, H.264, etc., are all designed for the natural images, and they are block-based encoding structure. In order to perform an internal prediction, prediction blocks are formed through linear combination of adjacent sample values which are selective and dependent on location, so as to remove a part of the spatial redundancy of the image. However, the method has a poor effect when the composite image is compressed. In the H.264 intra-frame prediction, the encoder and the decoder establish the prediction block samples using the sample values of adjacent blocks. In that case, the reference pixel is far away from the pixel, the prediction accuracy is poor and the encoding efficiency is low. Moreover, the reference pixel needs to be filtered before used usually, thereby increasing the calculation complexity. In addition, for the intra-frame prediction residual, the prior art deeply reduces the spatial redundancy using the Differential Pulse Code Modulation (DPCM). However, two times of predictions shall be carried out, thus the calculation complexity and the required time are both increased.

It is clear that if a composite image is compressed in the existing image compression method, the prediction accuracy is low and the calculation complexity is high.

The embodiments of the present invention provide an image compression apparatus and method, which can realize an accurate prediction in the compression of a composite image, thereby improving the quality of the compressed image and reducing the calculation complexity.

Detailed descriptions of the image compression apparatus and method of the present invention are given as follows with reference to the drawings.

### Embodiment 1

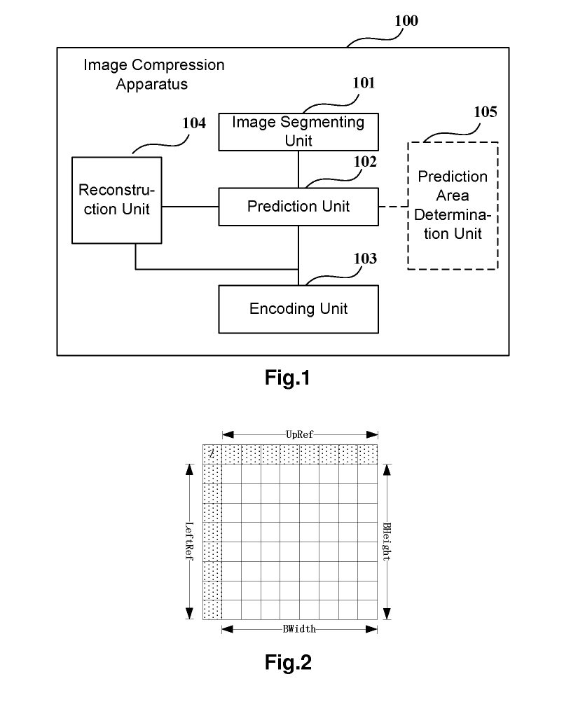

FIG. 1 is a structure diagram of an image compression apparatus according to Embodiment 1 of the present invention. As illustrated in FIG. 1, the image compression apparatus 100 includes an image segmenting unit 101, a prediction unit 102, an encoding unit 103 and a reconstruction unit 104, where,

the image segmenting unit 101 is configured to segment an original image into a plurality of image blocks according to a predetermined size combination;

the prediction unit 102 is configured to take an adjacent pixel, to which each pixel in each image block points in the same predetermined angle, as a reference pixel of the pixel, and take a pixel value or a reconstruction value of the reference pixel as a prediction value of the pixel; the encoding unit 103 is configured to encode a residual obtained by subtracting the prediction value from the pixel value of each pixel in each image block, or a quantization coefficient obtained through a transformation and a quantization of the residual; and

the reconstruction unit 104 is configured to add the prediction value of each pixel in each image block with corresponding residual or a residual obtained through an inverse transformation and an inverse quantization of the quantization coefficient, so as to obtain a reconstruction value of each pixel in each image block.

As can be seen from the above embodiment, an accurate prediction can be realized by taking an adjacent pixel as the reference pixel. In addition, it only requires taking the pixel value or the reconstruction value of the reference pixel as the prediction value of the pixel, thereby reducing the calculation complexity.

In this embodiment, for a lossless compression, an existing intra-frame prediction method may be used. But any filtering operation is not performed to the reference pixel.

In this embodiment, the image segmenting unit 101 is configured to segment an original image into a plurality of image blocks according to a predetermined size combination, where, for example, the predetermined size combination may be any combination of sizes such as 64×64, 32×32, 16×16, 8×8 and 4×4, where, the respective image blocks may have the same or different sizes. However, the size combination may be specifically selected according to the quality of the original image and the requirement of the image compression, which is not limited herein.

In this embodiment, for a lossless encoding, the encoding unit 103 directly encodes the residual, and the reconstruction value of each pixel obtained by the reconstruction unit 104 is the same as the original pixel value.

In this embodiment, preferably, the apparatus may further include a prediction area determination unit 105, which is optional and represented with dashed line in FIG. 1, where,

the prediction area determination unit 105 is configured to determine an area composed of each image block and a reference image block corresponding thereto as a prediction area of the image block; where the reference image block is a set of a column of pixels at the leftmost side and a row of pixels at the uppermost side.

On this basis, when determining the reference pixel of each pixel in each image block, the prediction unit 102 limits the reference pixel within the prediction area of the image block.

Thus, preferably, the reference pixel is limited within the prediction area, thereby further improving the prediction accuracy and reducing the calculation complexity. However, the present invention is not limited to be necessary to determine the prediction area.

In this case, for example, when corresponding reference pixel of a pixel in the image block exceeds the prediction area of the image block, the prediction unit 102 may take a reference pixel of an adjacent pixel of the pixel as a reference pixel of the pixel. However, the present invention is not limited thereto, and the reference pixel may also be limited within the prediction area in other manners.

In this embodiment, when the reference pixel of a pixel has a reconstruction value, the reconstruction value of the reference pixel may be taken as a prediction value of the pixel.

In this embodiment, adjacent pixels of a pixel represent pixels surrounding the pixel, but the present invention is not limited to the surrounding range. Preferably, a closest pixel among the adjacent pixels, to which each pixel in each image block points in the same predetermined angle, may be taken as the reference pixel of the pixel, thereby further improving the prediction accuracy. However, it is just a preferred manner and the present invention is not limited thereto.

FIG. 2 is a structure diagram of an image block to be processed and a reference image block according to this embodiment. As illustrated in FIG. 2, the description is made through an example in which the size of the image block to be processed is 8×8, but the present invention is not limited thereto, in which, ‘ [symbol] ’ represents the pixel of the reference image block, and ‘ [symbol] ’ represents the pixel of the image block to be processed; UpRef represents the pixel at the upper side of the reference image block, LeftRef represents the pixel at the left side of the reference image block, Z represents the pixel at the upper left corner of the reference image block, BHeight represents the height of the image block to be processed, and BWidth represents the width of the image block to be processed.

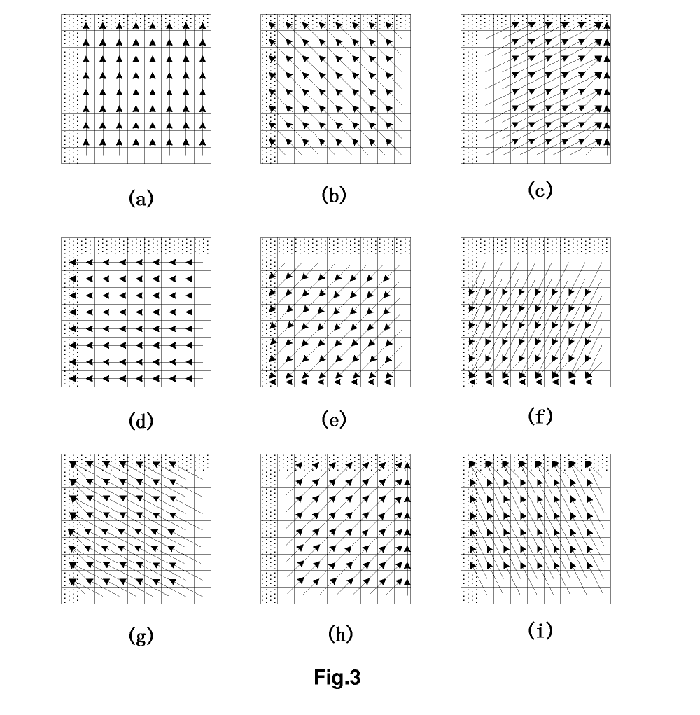

In this embodiment, the predetermined angle used by the prediction unit 102 may be any angle and it is not limited in the present invention. Different predetermined angles are corresponding to different prediction modes, and FIG. 3 is a schematic diagram of prediction modes according to this embodiment, which are described through the structure as illustrated in FIG. 2. However, those prediction modes are just described exemplarily, and the present invention is not limited thereto, i.e., the present invention is not limited to those predetermined angles. As illustrated in FIG. 3, the schematic diagrams of nine prediction modes are given, which are denoted as Figs. (a) to (i), respectively.

FIG. 3(a) is a schematic diagram of prediction mode 1, which is corresponding to a situation where the predetermined angle is 90 degrees. As illustrated in FIG. 3(a), an adjacent pixel, to which each pixel of the image block to be processed points in 90 degrees, is taken as a reference pixel of the pixel,

where, the prediction value of pixel (i, j) in the image block to be processed is:

$$\text{?} = \{ \begin{matrix}\text{?} & \text{?} = 0 \\ \text{?} , & \text{?} \neq 0\end{matrix} \\ \text{?} \text{indicates text missing or illegible when filed} \qquad ( 1 )$$

where, \tilde{r}_{i,j} represents the prediction value of pixel (i, j), UpRefⱼ represents the reference pixel in the same column as pixel (i, j) among the pixels at the upper side of the reference image block, i and j are integers equal to or larger than 0 and less than R, R represents the size of the image block to be processed, and in this embodiment, R=8.

FIG. 3(b) is a schematic diagram of prediction mode 2, which is corresponding to a situation where the predetermined angle is 135 degrees. As illustrated in FIG. 3(b), an adjacent pixel, to which each pixel of the image block to be processed points in 135 degrees, is taken as a reference pixel of the pixel,

where, the prediction value of pixel (i, j) in the image block to be processed is:

$$\text{?} = \{ \begin{matrix}\text{?} & i = 0 , j = 0 \\ {UpRef}_{j - 1} , & i = 0 , j \neq 0 \\ {LeftRef}_{i - 1} , & i \neq 0 , j = 0 \\ {r}_{i - 1 , j - 1} , & i \neq 0 , j \neq 0\end{matrix} \\ \text{?} \text{indicates text missing or illegible when filed} \qquad ( 2 )$$

FIG. 3(c) is a schematic diagram of prediction mode 3, which is corresponding to a situation where the predetermined angle is 30 degrees. As illustrated in FIG. 3(c), an adjacent pixel, to which each pixel of the image block to be processed points in 30 degrees, is taken as a reference pixel of the pixel,

where, the prediction value of pixel (i, j) in the image block to be processed is:

$$\text{?} = \{ \begin{matrix}{UpRef}_{j + 2} , & i = 0 , j < BWidth - 2 \\ \text{?} & i = 0 , j = BWidth - 2 \\ {UpRef}_{j} , & i = 0 , j = BWidth \text{?} \\ \text{?} & i \neq 0 , j < BWidth - 2 \\ \text{?} & i \neq 0 , j = BWidth - 2 \\ \text{?} , & i \neq 0 , j = BWidth - 1\end{matrix} \\ \text{?} \text{indicates text missing or illegible when filed} \qquad ( 3 )$$

FIG. 3(d) is a schematic diagram of prediction mode 4, which is corresponding to a situation where the predetermined angle is 180 degrees. As illustrated in FIG. 3(d), an adjacent pixel, to which each pixel of the image block to be processed points in 180 degrees, is taken as a reference pixel of the pixel,

where, the prediction value of pixel (i, j) in the image block to be processed is:

$$\text{?} = \{ \begin{matrix}\text{?} & j = 0 \\ \text{?} , & j \neq 0\end{matrix} \\ \text{?} \text{indicates text missing or illegible when filed} \qquad ( 4 )$$

FIG. 3(e) is a schematic diagram of prediction mode 5, which is corresponding to a situation where the predetermined angle is 225 degrees. As illustrated in FIG. 3(e), an adjacent pixel, to which each pixel of the image block to be processed points in 225 degrees, is taken as a reference pixel of the pixel,

where, the prediction value of pixel (i, j) in the image block to be processed is:

$$\text{?} = \{ \begin{matrix}\text{?} & i < BHeight - 1 , j = 0 \\ \text{?} , & i = BHeight - 1 , j = 0 \\ \text{?} , & i < BHeight - 1 , j \neq 0 \\ \text{?} , & i = Bheight - 1 , j \neq \text{?}\end{matrix} \\ \text{?} \text{indicates text missing or illegible when filed} \qquad ( 5 )$$

FIG. 3(f) is a schematic diagram of prediction mode 6, which is corresponding to a situation where the predetermined angle is 240 degrees. As illustrated in FIG. 3(f), an adjacent pixel, to which each pixel of the image block to be processed points in 240 degrees, is taken as a reference pixel of the pixel,

where, the prediction value of pixel (i, j) in the image block to be processed is:

$$\text{?} = \{ \begin{matrix}{LeftRef}_{i + 2} , & i < BHeight - 2 , i = 0 \\ \text{?} & i < BHeight - 1 , i = 0 \\ {LeftRef}_{i} , & i = BHeight \text{?} , i = 0 \\ \text{?} & i < BHeight - 2 , i \neq 0 \\ \text{?} & i < BHeight - 1 , i \neq 0 \\ \text{?} , & i = BHeight - 1 , i \neq 0\end{matrix} \\ \text{?} \text{indicates text missing or illegible when filed} \qquad ( 6 )$$

FIG. 3(g) is a schematic diagram of prediction mode 7, which is corresponding to a situation where the predetermined angle is 150 degrees. As illustrated in FIG. 3(g), an adjacent pixel, to which each pixel of the image block to be processed points in 150 degrees, is taken as a reference pixel of the pixel,

where, the prediction value of pixel (i, j) in the image block to be processed is:

$$\text{?} = \{ \begin{matrix}Z , & i = 0 , j < 2 \\ {UpRef}_{j - 2} , & i = 0 , j > 1 \\ {LeftRef}_{i - 2} , & i \neq 0 , j < 2 \\ {r}_{i - 1 , j - 2} , & i \neq 0 , j > 1\end{matrix} \\ \text{?} \text{indicates text missing or illegible when filed} \qquad ( 7 )$$

FIG. 3(h) is a schematic diagram of prediction mode 8, which is corresponding to a situation where the predetermined angle is 45 degrees. As illustrated in FIG. 3(h), an adjacent pixel, to which each pixel of the image block to be processed points in 45 degrees, is taken as a reference pixel of the pixel,

where, the prediction value of pixel (i, j) in the image block to be processed is:

$$\text{?} = \{ \begin{matrix}{UpRef}_{j + 1} , & i = 0 , j < BWidth - 1 \\ \text{?} & i = 0 , j = BWidth - 1 \\ {r}_{i - 1 , j + 1} , & i \neq 0 , j < BWidth - 1 \\ {r}_{i - 1 , j} , & i \neq 0 , j = BWidth - 1\end{matrix} \\ \text{?} \text{indicates text missing or illegible when filed} \qquad ( 8 )$$

FIG. 3(i) is a schematic diagram of prediction mode 9, which is corresponding to a situation where the predetermined angle is 120 degrees. As illustrated in FIG. 3(i), an adjacent pixel, to which each pixel of the image block to be processed points in 120 degrees, is taken as a reference pixel of the pixel,

where, the prediction value of pixel (i, j) in the image block to be processed is:

$$\text{?} = \{ \begin{matrix}Z , & i < 2 , j = 0 \\ \text{?} , & i = 0 , j > 0 \\ {LeftRef}_{i - 2} , & i > 1 , j = 0 \\ {r}_{i - 2 , j - 1} , & i > 1 , j > 0\end{matrix} \\ \text{?} \text{indicates text missing or illegible when filed} \qquad ( 9 )$$

The above nine prediction modes are just given for the exemplary descriptions of the present invention, and the present invention is not limited thereto, i.e., the present invention is not limited to those predetermined angles.

The prediction unit 102 obtains the prediction value of each pixel in each image block in the above method.

Next, the residual between each pixel and corresponding prediction value is calculated as follows:

Δr_{i,j}=r_{i,j}−\tilde{r}_{i,j} (10)

where, Δr_{i,j} represents the residual between pixel (i, j) and the prediction value, r_{i,j} represents the pixel value of the pixel, and \tilde{r}_{i,j} represents the prediction value of the pixel.

After obtaining the residual of each pixel in each image block, the encoding unit 103 encodes the residual between each pixel in each image block and corresponding prediction value to obtain the encoded bit stream, i.e., the compressed image data.

In this case, the method for encoding the residual between each pixel and corresponding prediction value may be any one of the existing encoding methods, e.g., the entropy encoding may be adopted, but the present invention is not limited thereto.

As can be seen from the above embodiment, an accurate prediction can be realized by taking the adjacent pixel as the reference pixel, thereby improving the quality of the compressed image. In addition, it only requires taking the pixel value or the reconstruction value of the reference pixel as the prediction value of the pixel, thereby reducing the calculation complexity. And for a lossless compression, an existing intra-frame prediction method may be used. But any filtering operation is not performed to the reference pixel, thereby reducing the calculation complexity.

Preferably, the reference pixel is limited within the prediction area, thereby further improving the prediction accuracy and reducing the calculation complexity.

Preferably, a closest pixel to which the pixel points is taken as the reference pixel of the pixel, thereby further improving the prediction accuracy.

### Embodiment 2

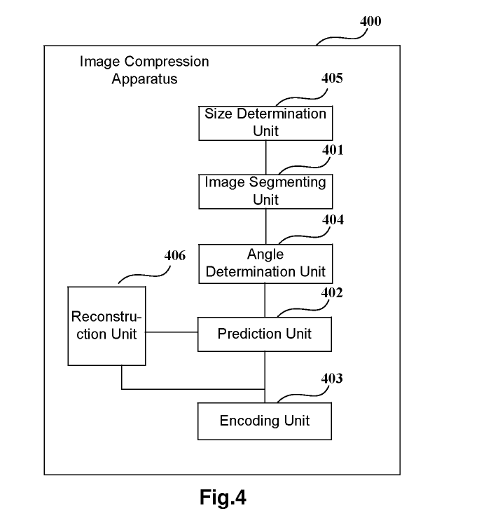

FIG. 4 is a structure diagram of an image compression apparatus according to Embodiment 2 of the present invention. As illustrated in FIG. 4, the image compression apparatus 400 includes an image segmenting unit 401, a prediction unit 402, an encoding unit 403, an angle determination unit 404 and/or a size determination unit 405, and a reconstruction unit 406, where,

the image segmenting unit 401, the prediction unit 402, the encoding unit 403 and the reconstruction unit 406 are the same as those described in Embodiment 1, and herein are omitted.

In this embodiment, the predetermined size combination and/or the predetermined angle for example may be determined by comparing the sums of the absolute values of the residuals, but the present invention is not limited thereto, and other existing methods for overhead calculation can also be adopted to select the optimal predetermined size and predetermined angle. For example, the transformation coefficients may also be obtained through residual transformation, so as to determine the predetermined size combination and/or predetermined angle by comparing the sums of the absolute values of the transformation coefficients.

The angle determination unit 404 is configured under different angles to take an adjacent pixel, to which each pixel in each image block points in the same angle, as a reference pixel of the pixel, and take a pixel value or a reconstruction value of the reference pixel as a prediction value of the pixel; to obtain the sums of the absolute values of the residuals of all the pixels in all the image blocks according to the residual obtained by subtracting the prediction value from the pixel value of each pixel in each image block; and to determine an angle corresponding to a minimum sum of the absolute values of the residuals as the predetermined angle according to the sums of the absolute values of the residuals of all the image blocks under different angles.

The size determination unit 405 is configured under different size combinations to segment an original image into a plurality of image blocks; to take an adjacent pixel, to which each pixel in each image block points in the same predetermined angle, as a reference pixel of the pixel, and take a pixel value or a reconstruction value of the reference pixel as a prediction value of the pixel; to obtain the sums of the absolute values of the residuals of all the pixels in all the image blocks according to the residual obtained by subtracting the prediction value from the pixel value of each pixel in each image block; and to determine a size combination corresponding to a minimum sum of the absolute values of the residuals as the predetermined size combination according to the sums of the absolute values of the residuals of all the image blocks under different size combinations.

In this embodiment, the angle determination unit 404 and the size determination unit 405 may be alternatively selected, i.e., the apparatus includes the angle determination unit 404 or the size determination unit 405. Or, both of them may be included, i.e., the apparatus includes the angle determination unit 404 and the size determination unit 405. The above situations may be selected upon the actual demand of the image compression, and herein is not limited.

In this embodiment, the range of the predetermined size combination, the range of the predetermined angle, the residual calculation method and the residual encoding method may be the same as those described in Embodiment 1, and herein are omitted.

In this embodiment, for a lossless compression, an existing intra-frame prediction method may be used. But any filtering operation is not performed to the reference pixel.

As can be seen from the above embodiment, an accurate prediction can be realized by taking the adjacent pixel as the reference pixel, thereby improving the quality of the compressed image. In addition, it only requires taking the pixel value or the reconstruction value of the reference pixel as the prediction value of the pixel, thereby reducing the calculation complexity. And for a lossless compression, an existing intra-frame prediction method may be used. But any filtering operation is not performed to the reference pixel, thereby reducing the calculation complexity. Moreover, the predetermined angle and/or the predetermined size combination corresponding to a minimum sum of the absolute values of the residuals is selected, thereby further improving the prediction accuracy and the quality of the compressed image.

### Embodiment 3

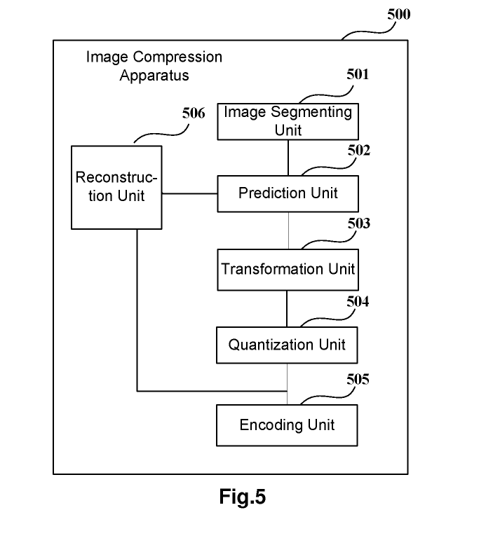

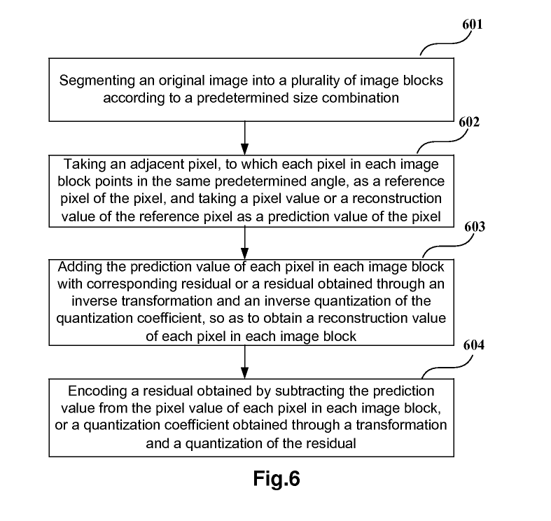

FIG. 5 is a structure diagram of an image compression apparatus according to Embodiment 3 of the present invention. As illustrated in FIG. 5, the image compression apparatus 500 includes an image segmenting unit 501, a prediction unit 502, a transformation unit 503, a quantization unit 504, an encoding unit 505 and a reconstruction unit 506, where,

the image segmenting unit 501, the prediction unit 502 and the reconstruction unit 506 are the same as those described in Embodiment 1 or 2, and herein are omitted.

The difference with Embodiment 1 or 2 is that the image compression apparatus according to this embodiment may further include the transformation unit 503 and the quantization unit 504, where,

the transformation unit 503 is configured to transform the residual of each pixel in each image block to obtain a transformation coefficient;

the quantization unit 504 is configured to quantize the transformation coefficient to obtain the quantization coefficient; and

the encoding unit 505 is configured to encode the quantization coefficient.

In this embodiment, the residual may be transformed and quantized in any of the existing methods, which is not limited herein.

In this embodiment, for a lossless compression, an existing intra-frame prediction method may be used. But any filtering operation is not performed to the reference pixel.

As can be seen from the above embodiment, an accurate prediction can be realized by taking the adjacent pixel as the reference pixel, thereby improving the quality of the compressed image. In addition, it only requires taking the pixel value or the reconstruction value of the reference pixel as the prediction value of the pixel, thereby reducing the calculation complexity. And for a lossless compression, an existing intra-frame prediction method may be used. But any filtering operation is not performed to the reference pixel, thereby reducing the calculation complexity. Moreover, through transformation and quantization of the residual, the quality of the compressed image can be further improved when the lossy image compression is performed.

### Embodiment 4

FIG. 6 is a flowchart of an image compression method according to Embodiment 4 of the present invention, which is corresponding to the image compression apparatus according to Embodiment 1. As illustrated in FIG. 6, the method includes:

Step 601: segmenting an original image into a plurality of image blocks according to a predetermined size combination;

Step 602: taking an adjacent pixel, to which each pixel in each image block points in the same predetermined angle, as a reference pixel of the pixel, and taking a pixel value or a reconstruction value of the reference pixel as a prediction value of the pixel;

Step 603: adding the prediction value of each pixel in each image block with corresponding residual or a residual obtained through an inverse transformation and an inverse quantization of the quantization coefficient, so as to obtain a reconstruction value of each pixel in each image block; and

Step 604: encoding a residual obtained by subtracting the prediction value from the pixel value of each pixel in each image block, or a quantization coefficient obtained through a transformation and a quantization of the residual.

In this embodiment, the range of the predetermined size combination, the range of the predetermined angle, the residual calculation method and the residual encoding method may be the same as those described in Embodiment 1, and herein are omitted.

In this embodiment, for a lossless compression, an existing intra-frame prediction method may be used. But any filtering operation is not performed to the reference pixel.

As can be seen from the above embodiment, an accurate prediction can be realized by taking the adjacent pixel as the reference pixel, thereby improving the quality of the compressed image. In addition, it only requires taking the pixel value or the reconstruction value of the reference pixel as the prediction value of the pixel, thereby reducing the calculation complexity. And for a lossless compression, an existing intra-frame prediction method may be used. But any filtering operation is not performed to the reference pixel, thereby reducing the calculation complexity.

### Embodiment 5

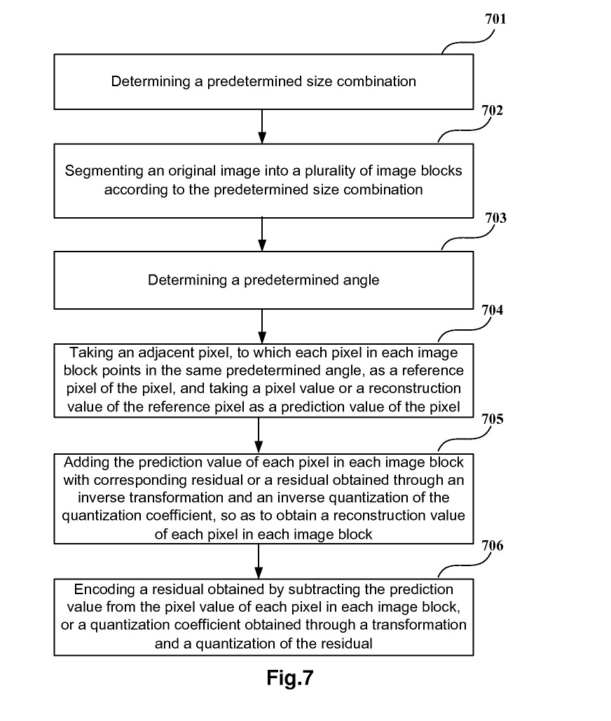

FIG. 7 is a flowchart of an image compression method according to Embodiment 5 of the present invention, which is corresponding to the image compression apparatus according to Embodiment 2. As illustrated in FIG. 7, the method includes:

Step 701: determining a predetermined size combination;

Step 702: segmenting an original image into a plurality of image blocks according to the predetermined size combination;

Step 703: determining a predetermined angle;

Step 704: taking an adjacent pixel, to which each pixel in each image block points in the same predetermined angle, as a reference pixel of the pixel, and taking a pixel value or a reconstruction value of the reference pixel as a prediction value of the pixel;

Step 705: adding the prediction value of each pixel in each image block with corresponding residual or a residual obtained through an inverse transformation and an inverse quantization of the quantization coefficient, so as to obtain a reconstruction value of each pixel in each image block; and

Step 706: encoding a residual obtained by subtracting the prediction value from the pixel value of each pixel in each image block, or a quantization coefficient obtained through a transformation and a quantization of the residual.

In this embodiment, step 701 and step 703 may be alternatively selected or both included. In addition, the orders of the two steps may be interchanged with each other, i.e., the predetermined size combination may be determined before the determination of the predetermined angle, or the predetermined angle may also be determined before the determination of the predetermined size. The above situations may be selected upon the actual demand of the image compression, and herein is not limited.

In this embodiment, the predetermined size combination and/or the predetermined angle for example may be determined by comparing the sums of the absolute values of the residuals, but the present invention is not limited thereto, and other existing methods for overhead calculation can also be adopted to select the optimal predetermined size and predetermined angle. For example, the transformation coefficients may also be obtained through residual transformation, so as to determine the predetermined size combination and/or predetermined angle by comparing the sums of the absolute values of the transformation coefficients.

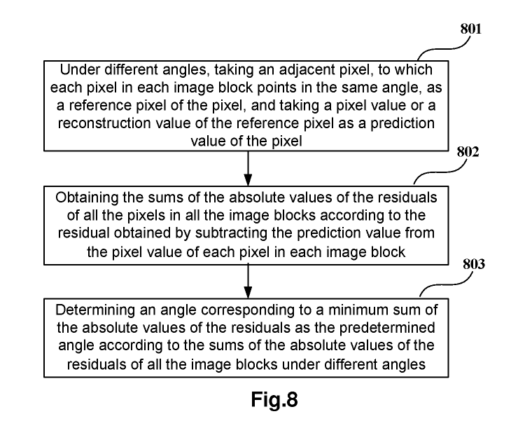

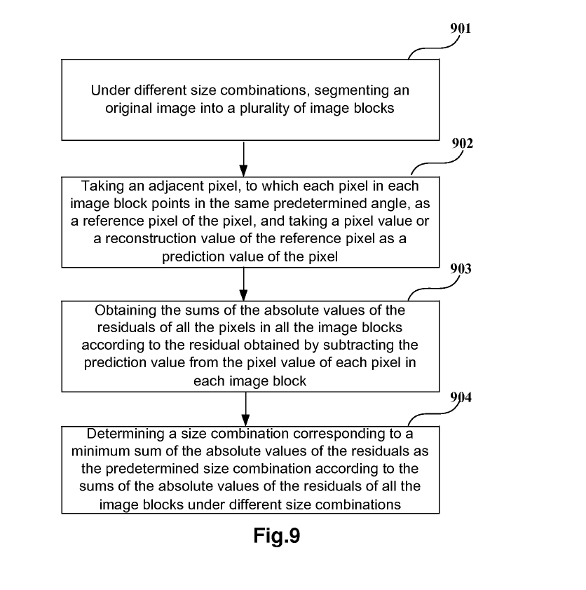

FIG. 8 is a flowchart of a method for determining a predetermined angle according to this embodiment. As illustrated in FIG. 8, the method includes:

Step 801: under different angles, taking an adjacent pixel, to which each pixel in each image block points in the same angle, as a reference pixel of the pixel, and taking a pixel value or a reconstruction value of the reference pixel as a prediction value of the pixel;

Step 802: obtaining the sums of the absolute values of the residuals of all the pixels in all the image blocks according to the residual obtained by subtracting the prediction value from the pixel value of each pixel in each image block; and

Step 803: determining an angle corresponding to a minimum sum of the absolute values of the residuals as the predetermined angle according to the sums of the absolute values of the residuals of all the image blocks under different angles.

FIG. 9 is a flowchart of a method for determining a predetermined size combination according to this embodiment. As illustrated in FIG. 9, the method includes:

Step 901: under different size combinations, segmenting an original image into a plurality of image blocks;

Step 902: taking an adjacent pixel, to which each pixel in each image block points in the same predetermined angle, as a reference pixel of the pixel, and taking a pixel value or a reconstruction value of the reference pixel as a prediction value of the pixel;

Step 903: obtaining the sums of the absolute values of the residuals of all the pixels in all the image blocks according to the residual obtained by subtracting the prediction value from the pixel value of each pixel in each image block; and

Step 904: determining a size combination corresponding to a minimum sum of the absolute values of the residuals as the predetermined size combination according to the sums of the absolute values of the residuals of all the image blocks under different size combinations.

In this embodiment, the range of the predetermined size combination, the range of the predetermined angle, the methods for determining the predetermined angle and the predetermined size combination, the residual calculation method and the residual encoding method may be the same as those described in Embodiment 1 or 2, and herein are omitted.

In this embodiment, for a lossless compression, an existing intra-frame prediction method may be used. But any filtering operation is not performed to the reference pixel.

As can be seen from the above embodiment, an accurate prediction can be realized by taking the adjacent pixel as the reference pixel, thereby improving the quality of the compressed image. In addition, it only requires taking the pixel value or the reconstruction value of the reference pixel as the prediction value of the pixel, thereby reducing the calculation complexity. And for a lossless compression, an existing intra-frame prediction method may be used. But any filtering operation is not performed to the reference pixel, thereby reducing the calculation complexity.

Moreover, the predetermined angle and/or the predetermined size combination corresponding to a minimum sum of the absolute values of the residuals is selected, thereby further improving the prediction accuracy and the quality of the compressed image.

### Embodiment 6

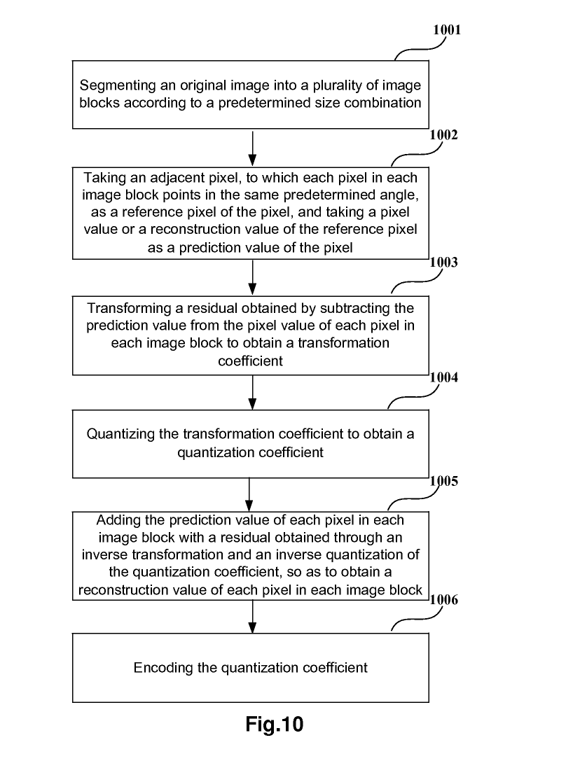

FIG. 10 is a flowchart of an image compression method according to Embodiment 6 of the present invention, which is corresponding to the image compression apparatus according to Embodiment 3. As illustrated in FIG. 10, the method includes:

Step 1001: segmenting an original image into a plurality of image blocks according to a predetermined size combination;

Step 1002: taking an adjacent pixel, to which each pixel in each image block points in the same predetermined angle, as a reference pixel of the pixel, and taking a pixel value or a reconstruction value of the reference pixel as a prediction value of the pixel;

Step 1003: transforming a residual obtained by subtracting the prediction value from the pixel value of each pixel in each image block to obtain a transformation coefficient;

Step 1004: quantizing the transformation coefficient to obtain a quantization coefficient; and

Step 1005: adding the prediction value of each pixel in each image block with a residual obtained through an inverse transformation and an inverse quantization of the quantization coefficient, so as to obtain a reconstruction value of each pixel in each image block; and

Step 1006: encoding the quantization coefficient.

In this embodiment, the range of the predetermined size combination, the range of the predetermined angle, the residual calculation method, and the methods for transforming, quantizing and encoding the residual may be the same as those described in Embodiment 1 or 3, and herein are omitted.

In this embodiment, for a lossless compression, an existing intra-frame prediction method may be used. But any filtering operation is not performed to the reference pixel.

As can be seen from the above embodiment, an accurate prediction can be realized by taking the adjacent pixel as the reference pixel, thereby improving the quality of the compressed image. In addition, it only requires taking the pixel value or the reconstruction value of the reference pixel as the prediction value of the pixel, thereby reducing the calculation complexity. And for a lossless compression, an existing intra-frame prediction method may be used. But any filtering operation is not performed to the reference pixel, thereby reducing the calculation complexity. Moreover, through transformation and quantization of the residual, the quality of the compressed image can be further improved when the lossy image compression is performed.

Moreover, like Embodiment 2, this embodiment may select the predetermined angle and/or the predetermined size combination corresponding to a minimum sum of the absolute values of the residuals, thereby further improving the prediction accuracy and the quality of the compressed image.

The above apparatuses and methods of the present invention may be implemented by hardware, or a combination of hardware and software, such as a programmed computer. The present invention relates to a computer readable program which when being executed by a logic part, enables the logic part to implement the aforementioned apparatus or constituent parts, or enables the logic part to implement the aforementioned methods or steps.

The present invention further relates to a storage medium for storing the above program, such as hard disc, magnetic disc, optical disc, DVD, flash, memory, etc.

The present invention is described as above in conjunction with specific embodiments. But a person skilled in the art shall appreciate that those descriptions are just exemplary, rather than limitations to the protection scope of the present invention. A person skilled in the art can make various modifications and changes to the present invention based on the spirit and the principle of the present invention, and those modifications and changes also fall within the scope of the present invention.

### Excursuses:

Excursus 1: an image compression apparatus, comprising:

an image segmenting unit configured to segment an original image into a plurality of image blocks according to a predetermined size combination;

a prediction unit configured to take an adjacent pixel, to which each pixel in each image block points in the same predetermined angle, as a reference pixel of the pixel, and take a pixel value or a reconstruction value of the reference pixel as a prediction value of the pixel;

an encoding unit configured to encode a residual obtained by subtracting the prediction value from the pixel value of each pixel in each image block, or a quantization coefficient obtained through a transformation and a quantization of the residual; and

a reconstruction unit configured to add the prediction value of each pixel in each image block with corresponding residual or a residual obtained through an inverse transformation and an inverse quantization of the quantization coefficient, so as to obtain a reconstruction value of each pixel in each image block.

Excursus 2: the apparatus according to Excursus 1, further comprising:

an angle determination unit configured under different angles to take an adjacent pixel, to which each pixel in each image block points in the same angle, as a reference pixel of the pixel, and take a pixel value or a reconstruction value of the reference pixel as a prediction value of the pixel; to obtain the sums of the absolute values of the residuals of all the pixels in all the image blocks according to the residual obtained by subtracting the prediction value from the pixel value of each pixel in each image block; and to determine an angle corresponding to a minimum sum of the absolute values of the residuals as the predetermined angle according to the sums of the absolute values of the residuals of all the image blocks under different angles.

Excursus 3: the apparatus according to Excursus 1 or 2, further comprising:

a size determination unit configured under different size combinations to segment an original image into a plurality of image blocks; to take an adjacent pixel, to which each pixel in each image block points in the same predetermined angle, as a reference pixel of the pixel, and take a pixel value or a reconstruction value of the reference pixel as a prediction value of the pixel; to obtain the sums of the absolute values of the residuals of all the pixels in all the image blocks according to the residual obtained by subtracting the prediction value from the pixel value of each pixel in each image block; and to determine a size combination corresponding to a minimum sum of the absolute values of the residuals as the predetermined size combination according to the sums of the absolute values of the residuals of all the image blocks under different size combinations.

Excursus 4: the apparatus according to Excursus 1, further comprising:

a transformation unit configured to transform the residual of each pixel in each image block to obtain a transformation coefficient; and

a quantization unit configured to quantize the transformation coefficient to obtain the quantization coefficient;

where the encoding unit is configured to encode the quantization coefficient.

Excursus 5: the apparatus according to any of Excursuses 1 to 4, further comprising:

a prediction area determination unit configured to determine an area composed of each image block and a reference image block corresponding thereto as a prediction area of the image block; where the reference image block is a set of a column of pixels at the leftmost side and a row of pixels at the uppermost side;

where when determining the reference pixel of each pixel in each image block, the prediction unit limits the reference pixel within the prediction area of the image block.

Excursus 6: the apparatus according to Excursus 5, where,

when corresponding reference pixel of a pixel in the image block exceeds the prediction area of the image block, the prediction unit takes a reference pixel of an adjacent pixel of the pixel as a reference pixel of the pixel.

Excursus 7: the apparatus according to any of Excursuses 1 to 4, where,

the prediction unit is configured to take a closest pixel among the adjacent pixels, to which each pixel in each image block points in the same predetermined angle, as the reference pixel of the pixel.

Excursus 8: an image compression method, comprising:

segmenting an original image into a plurality of image blocks according to a predetermined size combination;

taking an adjacent pixel, to which each pixel in each image block points in the same predetermined angle, as a reference pixel of the pixel, and taking a pixel value or a reconstruction value of the reference pixel as a prediction value of the pixel;

adding the prediction value of each pixel in each image block with corresponding residual or a residual obtained through an inverse transformation and an inverse quantization of the quantization coefficient, so as to obtain a reconstruction value of each pixel in each image block; and

encoding a residual obtained by subtracting the prediction value from the pixel value of each pixel in each image block, or a quantization coefficient obtained through a transformation and a quantization of the residual.

Excursus 9: The method according to Excursus 8, further comprising:

under different angles, taking an adjacent pixel, to which each pixel in each image block points in the same angle, as a reference pixel of the pixel, and taking a pixel value or a reconstruction value of the reference pixel as a prediction value of the pixel; obtaining the sums of the absolute values of the residuals of all the pixels in all the image blocks according to the residual obtained by subtracting the prediction value from the pixel value of each pixel in each image block; and determining an angle corresponding to a minimum sum of the absolute values of the residuals as the predetermined angle according to the sums of the absolute values of the residuals of all the image blocks under different angles.

Excursus 10: The method according to Excursus 8 or 9, further comprising:

under different size combinations, segmenting an original image into a plurality of image blocks; taking an adjacent pixel, to which each pixel in each image block points in the same predetermined angle, as a reference pixel of the pixel, and taking a pixel value or a reconstruction value of the reference pixel as a prediction value of the pixel; obtaining the sums of the absolute values of the residuals of all the pixels in all the image blocks according to the residual obtained by subtracting the prediction value from the pixel value of each pixel in each image block; and determining a size combination corresponding to a minimum sum of the absolute values of the residuals as the predetermined size combination according to the sums of the absolute values of the residuals of all the image blocks under different size combinations.

Excursus 11: The method according to Excursus 8, further comprising:

transforming the residual of each pixel in each image block to obtain a transformation coefficient; and

quantizing the transformation coefficient to obtain the quantization coefficient.

Excursus 12: the method according to any of Excursuses 8 to 11, further comprising:

determining an area composed of each image block and a reference image block corresponding thereto as a prediction area of the image block; where the reference image block is a set of a column of pixels at the leftmost side and a row of pixels at the uppermost side; and

when determining the reference pixel of each pixel in each image block, limiting the reference pixel within the prediction area of the image block.

Excursus 13: the method according to Excursus 12, where,

when corresponding reference pixel of a pixel in the image block exceeds the prediction area of the image block, a reference pixel of an adjacent pixel of the pixel is taken as a reference pixel of the pixel.

Excursus 14: the method according to any of Excursuses 8 to 11, where,

the taking the adjacent pixel, to which each pixel in each image block points in the same predetermined angle, as the reference pixel of the pixel comprises: taking a closest pixel among the adjacent pixels, to which each pixel in each image block points in the same predetermined angle, as the reference pixel of the pixel.

1. An image compression apparatus, comprising:
an image segmenting unit configured to segment an original image into a plurality of image blocks according to a predetermined size combination;
a prediction unit configured, relative to a target pixel, to take an adjacent pixel, to which each pixel in each image block points in a same predetermined angle, as a reference pixel of the target pixel, and take one of a pixel value and a reconstruction value of the reference pixel as a prediction value of the target pixel;
an encoding unit configured to encode one of a residual obtained by subtracting the prediction value from the pixel value of each pixel in each image block and a quantization coefficient obtained through transformation and quantization of the residual; and
a reconstruction unit configured to add one of the prediction value of each pixel in each image block with corresponding residual and a residual obtained through an inverse transformation to an inverse quantization of the quantization coefficient, to obtain a reconstruction value of each pixel in each image block.

2. The apparatus according to claim 1, further comprising:
an angle determination unit configured under different angles to take the adjacent pixel, to which each pixel in each image block points in the same predetermined angle, as a reference pixel of the pixel, and take one of a pixel value and a reconstruction value of the reference pixel as a prediction value of the pixel, to obtain sums of absolute values of residuals of all the pixels in all the image blocks according to the residual obtained by subtracting the prediction value from the pixel value of each pixel in each image block; and to determine an angle corresponding to a minimum sum of the absolute values of the residuals as the predetermined angle according to the sums of the absolute values of the residuals of all the image blocks under different angles.

3. The apparatus according to claim 1, further comprising:
a size determination unit configured under different size combinations to segment an original image into a plurality of image blocks; to take an adjacent pixel, to which each pixel in each image block points in the same predetermined angle, as a reference pixel of the pixel, and take one of a pixel value and a reconstruction value of the reference pixel as a prediction value of the pixel; to obtain sums of absolute values of the residuals of all the pixels in all the image blocks according to the residual obtained by subtracting the prediction value from the pixel value of each pixel in each image block; and to determine a size combination corresponding to a minimum sum of the absolute values of the residuals as the predetermined size combination according to the sums of the absolute values of the residuals of all the image blocks under different size combinations.

4. The apparatus according to claim 1, further comprising:
a transformation unit configured to transform the residual of each pixel in each image block to obtain a transformation coefficient; and
a quantization unit configured to quantize the transformation coefficient to obtain the quantization coefficient;
wherein the encoding unit is configured to encode the quantization coefficient.

5. The apparatus according to claim 1, further comprising:
a prediction area determination unit configured to determine an area composed of each image block and a reference image block corresponding thereto as a prediction area of the image block;
wherein the reference image block is a set of a column of pixels at a leftmost side and a row of pixels at an uppermost side;
wherein when determining the reference pixel of each pixel in each image block, the prediction unit limits the reference pixel to be within the prediction area of the image block.

6. The apparatus according to claim 5, wherein, when a corresponding reference pixel of a pixel in the image block exceeds the prediction area of the image block, the prediction unit takes a reference pixel of the adjacent pixel of the pixel as a reference pixel of the pixel.

7. The apparatus according to claim 1, wherein, the prediction unit is configured to take a closest pixel among adjacent pixels, to which each pixel in each image block points in the same predetermined angle, as the reference pixel of the pixel.

8. An image compression method, comprising:
segmenting an original image into a plurality of image blocks according to a predetermined size combination;
taking an adjacent pixel, to a pixel to which each pixel in each image block points in a same predetermined angle, as a reference pixel of the pixel, and taking one of a pixel value and a reconstruction value of the reference pixel as a prediction value of the pixel;
adding the prediction value of each pixel in each image block with one of a corresponding residual and a residual obtained through an inverse transformation to an inverse quantization of the quantization coefficient to obtain a reconstruction value of each pixel in each image block; and
encoding a residual obtained by one of subtracting the prediction value from the pixel value of each pixel in each image block and a quantization coefficient obtained through transformation and quantization of the residual.

9. The method according to claim 8, further comprising:
under different angles, taking an adjacent pixel, to which each pixel in each image block points in a same angle, as a reference pixel of the pixel, and taking one of a pixel value and a reconstruction value of the reference pixel as a prediction value of the pixel; obtaining sums of absolute values of the residuals of all the pixels in all the image blocks according to the residual obtained by subtracting the prediction value from the pixel value of each pixel in each image block; and determining an angle corresponding to a minimum sum of absolute values of the residuals as the same predetermined angle according to sums of the absolute values of the residuals of all the image blocks under different angles.

10. The method according to claim 8, further comprising:
under different size combinations, segmenting an original image into a plurality of image blocks; taking an adjacent pixel, to which each pixel in each image block points in the same predetermined angle, as a reference pixel of the pixel, and taking one of a pixel value and a reconstruction value of the reference pixel as a prediction value of the pixel; obtaining sums of the absolute values of the residuals of all the pixels in all the image blocks according to the residual obtained by subtracting the prediction value from the pixel value of each pixel in each image block; and determining a size combination corresponding to a minimum sum of absolute values of the residuals as a predetermined size combination according to sums of the absolute values of the residuals of all the image blocks under different size combinations.

11. The method according to claim 8, further comprising:
transforming the residual of each pixel in each image block to obtain a transformation coefficient; and
quantizing the transformation coefficient to obtain the quantization coefficient.

12. The method according to claim 8, further comprising:
determining an area composed of each image block and a reference image block corresponding thereto as a prediction area of the image block;
wherein the reference image block is a set of a column of pixels at a leftmost side and a row of pixels at an uppermost side; and
when determining the reference pixel of each pixel in each image block, limiting the reference pixel to be within the prediction area of the image block.

13. The method according to claim 8, wherein, when a corresponding reference pixel of a pixel in the image block exceeds the prediction area of the image block, a reference pixel of the adjacent pixel of the pixel is taken as a reference pixel of the pixel.

14. The method according to claim 8, wherein, the taking the adjacent pixel, to which each pixel in each image block points in the same predetermined angle, as the reference pixel of the pixel comprises: taking a closest pixel among the adjacent pixels, to which each pixel in each image block points in the same predetermined angle, as the reference pixel of the pixel.

15. A method, comprising:
designating a first pixel adjacent to a second pixel as a reference pixel and designating the reference pixel as a prediction value; and
adding the prediction value to a corresponding pixel residual to produce a reconstruction value of the second pixel.

16. The method according to claim 15, wherein the designating is limited to pixels within a prediction area.
